(19) United States
(12) Patent Application Publication
(10) Pub. No.: US 2014/0071665 A1
(43) Pub. Date: Mar. 13, 2014

(54) ILLUMINATION LAMP APPLIED AT LIGHT STEEL FRAME

(71) Applicant: Chin-Cheng HUANG, New Taipei City (TW)

(72) Inventor: Chin-Cheng HUANG, New Taipei City (TW)

(21) Appl. No.: 13/612,814

(22) Filed: Sep. 12, 2012

(51) Int. Cl. F21S 4/00; F21V 17/16; F21V 7/00; F21V 29/00; F21V 13/02

(52) U.S. Cl. 362/218

(57) ABSTRACT

An illumination lamp applied at a light steel frame includes a panel, a light exiting plate, a heat dissipating cover and an LED strip. The panel has an opening; the light exiting plate is fixed to the panel and covered onto the opening; the heat dissipating cover is corresponsive to the light exiting plate and detachably installed at the panel and has a top plate and a surrounding plate coupled to the top plate, and the surrounding plate includes a pair of aslant side plate and a pair of side plates corresponding to a pair of adjacent aslant side plates, and an end of the pair of aslant side plates away from the top plate has a width greater than the width of an end proximate to the top plate; and the LED strip is flatly attached onto the internal side of the top plate.

### FIELD OF THE INVENTION

The present invention relates to an illumination lamp, in particular to the illumination lamp applied at a light steel frame.

### BACKGROUND OF THE INVENTION

Light emitting diode (LED) can be used as a light source and installed at a light steel frame of a ceiling. With reference to FIG. 1 for a conventional illumination lamp, the conventional illumination lamp comprises a frame 8 and a circuit board 9 having a plurality of LED elements 91 installed thereon. The frame 8 is hollow and has a downwardly opened square slot 81 and the frame 8 is a flat square body, and the circuit board 9 is substantially in a square shape and fixed on an internal top side of the frame 8, and the square open slot 81 of the frame 8 is combined with a transparent plate (not labeled with a numeral in the figure).

Although the aforementioned conventional illumination lamp can provide illumination, the volume of the frame 8 is too large, thus incurring a waste of materials and a high cost. In addition, the conventional illumination lamp generally has a large number of LED elements 91 densely installed thereon to improve the brightness, but such lamp still has the drawbacks of wasting energy and failing to comply with the power-saving requirements.

Therefore, it is a main subject for the present invention to design an illumination lamp to overcome the aforementioned drawbacks of the prior art.

### SUMMARY OF THE INVENTION

It is a primary objective of the present invention to provide an illumination lamp applied at a light steel frame having a smaller heat dissipating cover and less LED strips and achieving a better power saving effect and a lower cost while maintaining the same illumination range of the conventional lamp.

To achieve the foregoing objective, the present invention provides an illumination lamp applied at a light steel frame, comprising: a panel, having at least one opening; at least one light exiting plate, fixed to the panel and covered onto a position corresponding to the opening; at least one heat dissipating cover, corresponding to the light exiting plate and detachably installed onto the panel, and the heat dissipating cover having a top plate and a surrounding plate coupled to the top plate, and the surrounding plate including a pair of aslant side plates and a pair of side plates corresponding to the pair of adjacently aslant side plates, and an end of the pair of aslant side plates away from the top plate has a width greater than the width of an end proximate to the top plate; and at least one LED strip, flatly attached onto an internal side of the top plate.

Compared with the prior art, the present invention has the following effects. The heat dissipating cover comes with a design of a trapezoid which is capable of fixing the LED strips onto the internal top side of heat dissipating cover (which is the internal side of the top plate) to increase the illumination height, in addition to the effects of reducing the volume and lowering the cost. The present invention can further fix the LED strips onto the heat dissipating cover in form of the trapezoid to provide the light guide effect, so as to expand the illumination range. In other words, the invention can reduce the volume of the heat dissipating cover and the number of LED strips while maintaining the same illumination range of the conventional illumination lamp, so as to provide a better energy saving effect and lower the cost.

### BRIEF DESCRIPTION OF THE DRAWINGS

FIG. 1 is a perspective view of a conventional illumination lamp;

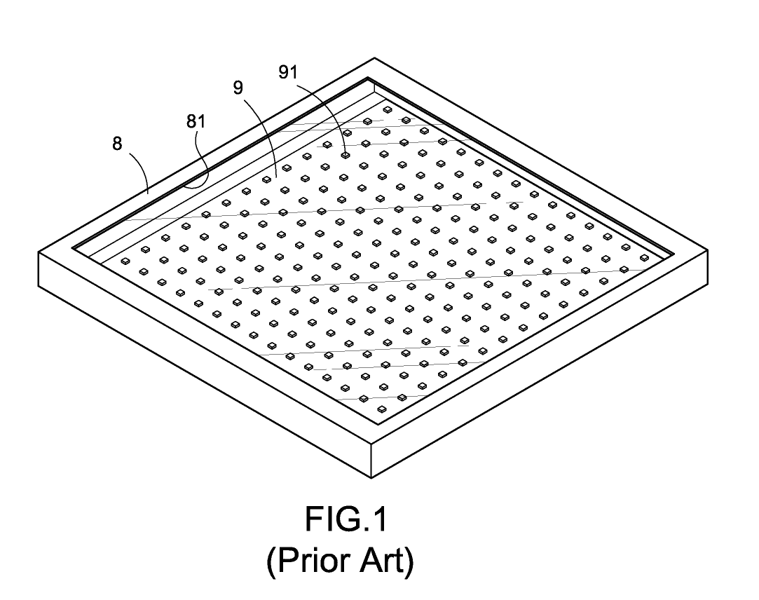

FIG. 2 is an exploded view of an illumination lamp in accordance with the present invention;

FIG. 3 is a schematic view showing the relation between an illumination lamp and a light steel frame in accordance with the present invention after the lamp is installed;

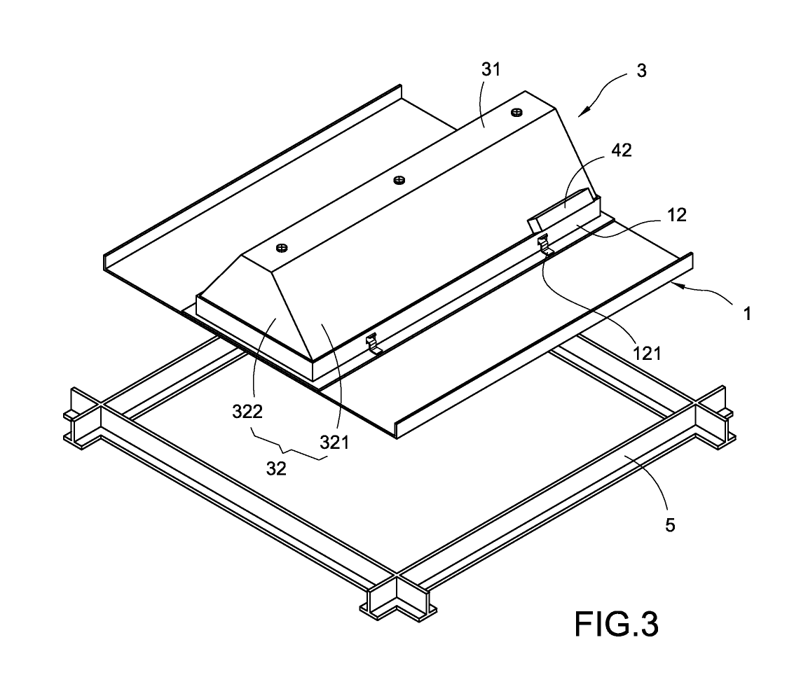

FIG. 4 is a cross-sectional view of an assembly of the present invention as depicted in FIG. 3; and

FIG. 5 is a cross-sectional view of an illumination lamp in accordance with another preferred embodiment of the present invention.

### DESCRIPTION OF THE PREFERRED EMBODIMENTS

The technical contents of the present invention will become apparent with the detailed description of preferred embodiments accompanied with the illustration of related drawings as follows.

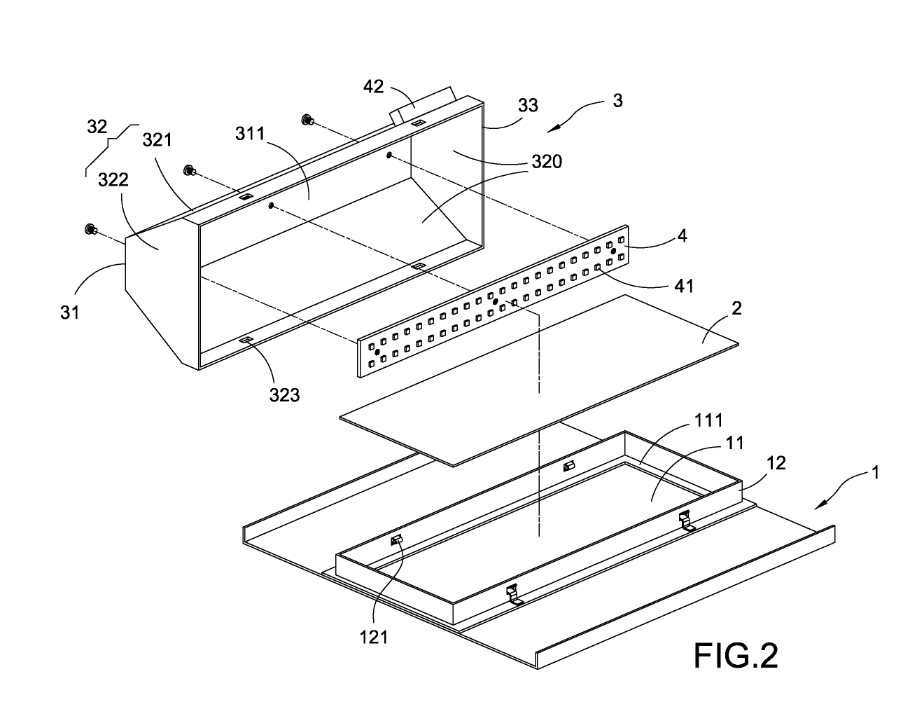

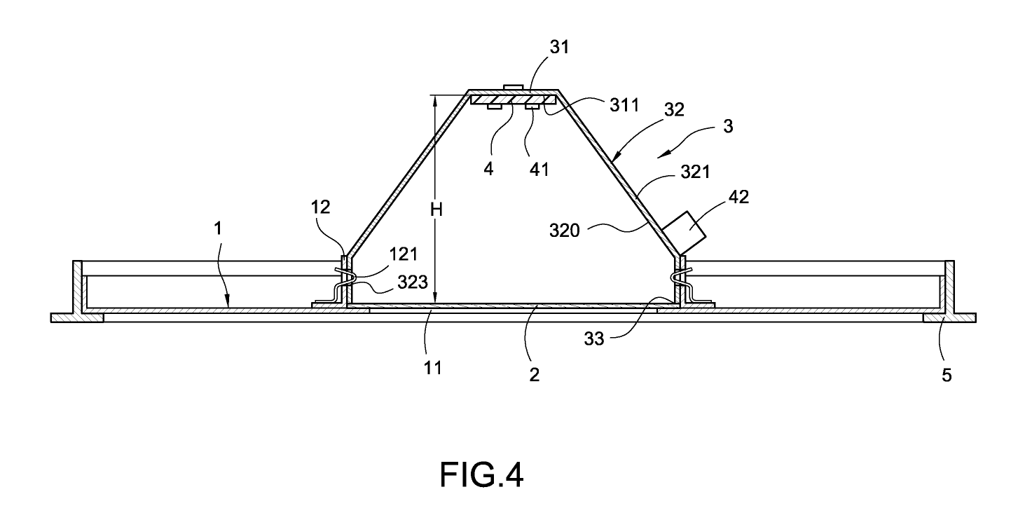

With reference to FIGS. 2 and 4 for an illumination lamp for an illumination lamp applied at a light steel frame in accordance with the present invention, an LED element 41 is used as a light emitting source and installed onto a light steel frame 5 of a ceiling, and the illumination lamp comprises a panel 1, a light exiting plate 2, a heat dissipating cover 3 and an LED strip 4.

The panel 1 is a rectangular plate with an opening 11 formed thereon, and the light exiting plate 2 is fixed to panel 1 and covered at a position corresponding to the opening 11 as shown in the figures. The panel 1 has a circular internal flange 111 protruded from the periphery of the opening 11, and the light exiting plate 2 is fixed onto an internal flange 111 of the panel 1. In addition, the light exiting plate 2 can be a light transmitting plate, or a plate comprising a light guide film and a diffusion film stacked with one another (not shown in the figure).

The heat dissipating cover 3 corresponds to the light exiting plate 2 and detachably installed onto the panel 1, and the heat dissipating cover 3 has a top plate 31 and a surrounding plate 32 coupled to the top plate 31, wherein the surrounding plate 32 includes a pair of aslant side plates 321 and a pair of side plates 322 disposed adjacent to the pair of aslant side plates 321, and an end of the pair of aslant side plates 321 away from the top plate 31 (which is the lower end of the pair of aslant side plates) has a width greater than the width of an end proximate to the top plate 31 (which is the upper end of the pair of aslant side plates) as shown in FIG. 4. The top plate 31 has an internal side 311, and a bottom opening 33 is enclosed by the lower ends of the pair of aslant side plates 321 and the pair of side plates 322 as shown in the figure. The panel 1 further has an upper flange 12 disposed around the periphery of the opening 11, and the upper flange 12 includes a plurality of elastic snap fasteners 121. The surrounding plate 32 of the heat dissipating cover 3 has a plurality of snap holes 323 corresponding to the elastic snap fasteners 121 as shown in the figure, and the snap holes 323 are formed at the lower end of the pair of aslant side plates 321, such that each elastic snap fastener 121 of the panel 1 can be detachably and flexibly snapped into each snap hole 323 of the pair of aslant side plates 321. In other words, the heat dissipating cover 3 can be snapped into the snap holes 323 by the elastic snap fasteners 121 and detachably installed onto the panel 1. In addition, the internal side of the surrounding plate 32 of the heat dissipating cover 3 is a reflecting surface 320, so that light in the heat dissipating cover 3 has a better reflection effect to enhance the brightness. The heat dissipating cover 3 has a length equal to the length of the panel 1 as shown in the figure or smaller than the length of the panel 1.

The panel 1 can be a plate of different shapes, such as square or rectangular, and the shape of the heat dissipating cover 3 is substantially rectangular with two long sides and two short sides (viewing from the top or bottom side). Viewing from one of the short sides of the heat dissipating cover 3, a tapered trapezoid (with a wider bottom opening 33 and a narrower top plate 31) can be observed, so that a height H is defined between the internal side of the top plate 31 of the heat dissipating cover 3 and the light exiting plate 2 as shown in FIG. 4.

The LED strip 4 is substantially a long-strip plate with a plurality of LED elements 41 installed thereon, and the LED elements 41 will generate heat. The aforementioned top plate 31 has an internal side 311 in a long flat shape corresponding to the shape of the LED strip 4, so that the LED strip 4 can be flatly attached onto the internal side 311 of the top plate 31. In other words, the LED strip 4 and the internal side of the top plate 31 forms a large contact area to provide a better heat conductivity, so as to accelerate the conduction of the heat generated by the LED elements 41 to the heat dissipating cover 3 made of metal for heat dissipation. In addition, the aforementioned heat dissipating cover 3 has a power-on circuit unit 5 fixed onto the external side of the heat dissipating cover 3 and electrically coupled to the LED strip 4 for controlling the LED element 41 of the LED strip 4.

With reference to FIG. 4, the LED strip 4 is fixed onto the internal side 31 of the top plate 311, so that the aforementioned height H from the light exiting plate 2 is still defined. Therefore, the height (where the LED strip 4 of the illumination lamp of the present invention is situated) is greater than that of the conventional illumination lamp. In addition the solid from the top plate 31 (wherein the LED strip 4 is situated) to the bottom opening 33 (wherein the light exiting plate 2 is situated) is an upwardly tapered trapezoid, so as to facilitate the light guide effect of light scattering. As a result, the illumination lamp of the present invention can expand the illumination range or provide a better light scattering. In addition, the internal side of the surrounding plate 32 is a reflecting surface 320, so that the heat dissipating cover 3 also has the light reflection function to provide a better light reflection effect inside the heat dissipating cover 3 to enhance the brightness of the illumination lamp.

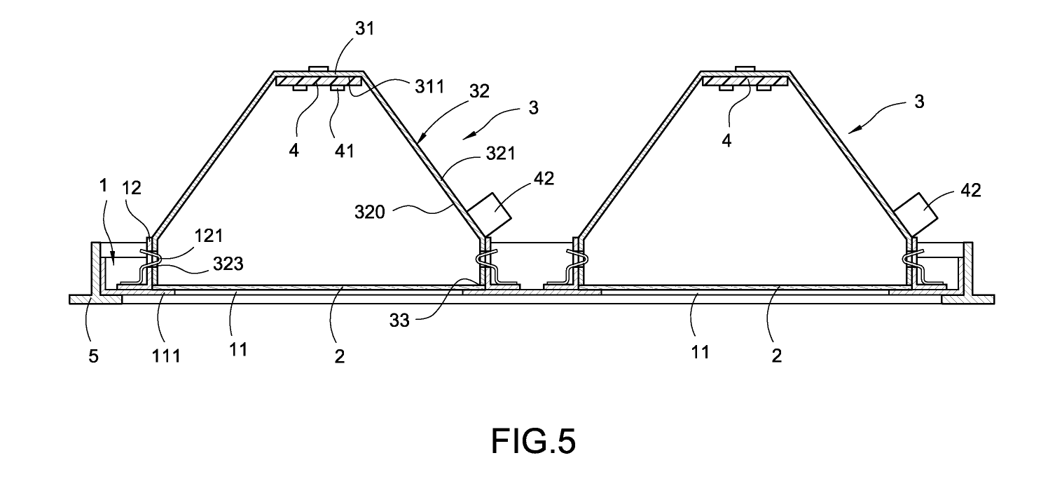

With reference to FIG. 5 for another preferred embodiment of the present invention, this preferred embodiment is substantially the same as the previous preferred embodiment, and the difference (as shown in FIGS. 2 and 4) resides on that the panel 1 has a plurality of openings 11 (there are two openings 11 shown in the figure), a plurality of light exiting plates 2 fixed onto the panel 1 and covered onto each opening 11, a plurality of heat dissipating covers 3 corresponding to each light exiting plate 2 and detachably installed onto the panel 1, a plurality of LED strips 4 flatly attached onto the internal side 311 of the top plate 31 of each heat dissipating cover 3, and a plurality of power-on circuit units 42 is separately fixed onto each heat dissipating cover 3 and electrically coupled to the LED strip 4 in the heat dissipating cover 3, so that a single panel 1 can have a plurality of LED strips 4 for the illumination. On the other hand, the heat dissipating cover 3, the LED strip 4 and the power-on circuit unit 42 can be combined into a modular illumination module, and a plurality of illumination modules can be installed on the panel 1 and covered onto each opening 11 to facilitate the installation and save the time and effect for the installation.

In summation of the description above, the illumination lamp applied at a light steel frame in accordance with the present invention has the following effects: The heat dissipating cover 3 comes with a design of a trapezoid instead of a conventional rectangular cuboid, not only decreasing the volume, reducing the material for the manufacture, and lowering the related costs, but also fixing the LED strip 4 on the internal side 311 of the top plate 31 of the heat dissipating cover 3 to increase the illumination height (H) and providing the heat dissipating cover 3 designed as an (upwardly tapered) trapezoid for dissipating heat and facilitating the light guide effect of the light scattering, so as to expand the illumination range (or improve the light diffusion). In other words, the illumination lamp of the present invention can achieve the effect of a smaller heat dissipating cover 3, less LED strips 4, less LED elements 41 while maintaining the same illumination range of the conventional illumination lamp, providing a better energy saving effect and lowering the cost. In addition, the internal side of the surrounding plate 32 of the heat dissipating cover 3 is a reflecting surface 320, so that the heat dissipating cover 3 can have the light reflection function in addition to the heat dissipation and light guide functions, so as to provide a better light reflection inside the heat dissipating cover 3 and further enhance the brightness and performance of the illumination lamp. With the internal side of the surrounding plate 32 of the heat dissipating cover 3, the brightness of the light reflected from the reflecting surface 320 can be improved, so that no additional reflection plate or its related cost is required. The large contact area is between the LED strip 4 and the internal side 311 of the top plate 31 of the heat dissipating cover 3 to provide a high thermal conduction efficiency and conduct the heat generated from the LED elements 41 to the metal heat dissipating cover 3 quickly, and the heat dissipating cover 3, the LED strip 4 and the power-on circuit unit 42 can be combined into a modular illumination module, so that the illumination modules can be installed on the panel 1 and covered separately onto each opening 11 to achieve the effects of facilitating the installation and saving the time and effort of the installation.

In summation of the description above, the present invention improves over the prior art and complies with the patent application requirements and thus is dual filed for patent application. While the invention has been described by means of specific embodiments, numerous modifications and variations could be made thereto by those skilled in the art without departing from the scope and spirit of the invention set forth in the claims.

What is claimed is:

1. An illumination lamp applied at a light steel frame, comprising:
a panel, having at least one opening;
at least one light exiting plate, fixed to a the panel and covered onto the opening;
at least one heat dissipating cover, corresponding to the light exiting plate, and installed onto or removed from the panel, and the heat dissipating cover having a top plate and a surrounding plate coupled to the top plate, and the surrounding plate including a pair of aslant side plates installed opposite to each other and a pair of side plates disposed adjacent to the pair of aslant side plates, and an end of the aslant side plate away from the top plate has a width greater than the width of an end of the adjacent top plate; and
at least one LED strip, flatly attached onto an internal side of the top plate.

2. The illumination lamp applied at a light steel frame according to claim 1, wherein the heat dissipating cover is an upwardly tapered trapezoid, and the LED strip is a long-strip, and the internal side of the top plate of the heat dissipating cover is in form of a long flat surface disposed opposite to the LED strip.

3. The illumination lamp applied at a light steel frame according to claim 1, wherein the internal side of the surrounding plate of the heat dissipating cover is a reflecting surface.

4. The illumination lamp applied at a light steel frame according to claim 1, wherein the light exiting plate is a light transmitting plate.

5. The illumination lamp applied at a light steel frame according to claim 1, wherein the light exiting plate comprises a light guide film and a diffusion film stacked and coupled with one another.

6. The illumination lamp applied at a light steel frame according to claim 1, wherein the heat dissipating cover has a power-on circuit unit fixed on an external side of the heat dissipating cover and electrically coupled to the LED strip.

7. The illumination lamp applied at a light steel frame according to claim 1, wherein the panel has an internal flange protruded from and disposed around the periphery of the opening, and the light exiting plate is fixed onto the internal flange of the panel.

8. The illumination lamp applied at a light steel frame according to claim 1, wherein the panel has an upper flange disposed at the position around the periphery of the opening, and the upper flange has a plurality of elastic snap fasteners, and the surrounding plate of the heat dissipating cover has a plurality of snap holes corresponding to the elastic snap fasteners, and each elastic snap fastener of the panel is elastically snapped into each snap hole of the surrounding plate of the heat dissipating cover.

9. The illumination lamp applied at a light steel frame according to claim 8, wherein the snap holes of the surrounding plate are formed at an end of the pair of aslant side plates away from the top plate.
